(19) United States
(12) Patent Application Publication
(10) Pub. No.: US 2018/0308298 A1
(43) Pub. Date: Oct. 25, 2018

(54) SEMI-AUTOMATED DRONE FOR AVIONICS NAVIGATION SIGNAL VERIFICATION AND METHODS OF OPERATION AND USE THEREOF

(71) Applicant: THALES USA, INC., Arlington, VA (US)

(72) Inventors: Abhyudaya Reddy ELUGANTI, Clarksburg, MD (US); Art MEZINS, Clarksburg, MD (US)

(21) Appl. No.: 15/758,597

(22) PCT Filed: Nov. 9, 2016
(86) PCT No.: PCT/US2016/061194

§ 371 Date: Mar. 8, 2018

Related U.S. Application Data
(60) Provisional application No. 62/253,641, filed on Nov. 10, 2015.

(51) Int. Cl. G07C 5/08; G07C 5/00; G01C 23/00; G01C 25/00; B64D 43/00; B64D 45/04; B64C 39/02

(52) U.S. Cl. CPC G07C 5/0808; G07C 5/008; G01C 23/00; B64C 39/024; B64D 43/00; B64D 45/04; G01C 25/00

(57) ABSTRACT

A method, system, and computer-readable medium for performing a flight check of one or more navigational aid systems. Aspects include determining, using an unmanned aircraft, an accuracy of signals transmitted by a localiser. Aspects also include determining, using the unmanned aircraft, an accuracy of signals transmitted by a glide slope station.

### CROSS-REFERENCE TO RELATED APPLICATION(S)

This application claims the benefit of U.S. Provisional Application Ser. No. 62/253,641, entitled “Semi-Automated Drone for Avionics Navigation Signal Verification and Methods of Operation and Use Thereof” and filed on Nov. 10, 2015, which is expressly incorporated by reference herein in its entirety.

### TECHNICAL FIELD

The disclosure relates generally to the field of avionics, and more specifically to devices, systems, and methods for performing a flight check of one or more navigational aid systems using an unmanned aircraft.

### BACKGROUND

Pilots generally rely on very high frequency (VHF) omnidirectional range (VOR) navigation systems, instrument landing systems (ILSs), and/or distance measuring equipment (DME) to aid with navigation and landing when flying during periods of low visibility or inclement weather. Generally, a VOR system is implemented by dispersing VOR transmitter facilities across a geographic area. VOR receivers, located on the aircraft, receive signals from VOR transmitters and help guide the aircraft through such geographic areas. The basic principle of operation of the VOR navigation system may include the VOR transmitter transmitting two signals at the same time. One VOR signal may be transmitted constantly in all directions, while another signal is rotatably transmitted about the VOR transmission facility. The airborne VOR receiver receives both signals, analyzes the phase difference between the two signals, and interprets the results as a radial to or from the VOR transmitter. Thus, the VOR navigation system allows a pilot to simply, accurately, and without ambiguity navigate from VOR transmitter facility to VOR transmitter facility. Each VOR transmission facility operates at a frequency that is different from the surrounding VOR transmitters. Therefore a pilot may tune the aircraft VOR receiver to the VOR transmission facility with respect to which navigation is desired.

The ILS is a ground-based instrument approach system that provides aircraft with lateral guidance (e.g., from localizer antenna array) and vertical guidance (e.g., glide slope antenna array) while approaching and landing on a runway. In principle, an aircraft approaching a runway is guided by ILS receivers in the aircraft that perform modulation depth comparisons of signals transmitted by a localizer antenna array located at the end of the runway and by a glide slope antenna array located to one side of the runway touchdown zone.

Generally speaking, two signals are transmitted by the localizer from co-located antennas within the array. One signal is modulated at a first frequency (e.g., 90 Hz), while the other signal is modulated at a second frequency (e.g., 150 Hz). Each of the co-located antennas transmits a narrow beam, one slightly to the left of the runway centerline, the other slightly to the right of the runway centerline. The localizer receiver in the aircraft measures the difference in the depth of modulation (DDM) of the first signal (e.g., 90 Hz) and the second signal (e.g., 150 Hz). The depth of modulation for each of the modulating frequencies is 20 percent when the receiver is on the centerline. The difference between the two signals varies depending on the deviation of the approaching aircraft from the centerline. The pilot controls the aircraft so that a localizer indicator (e.g., cross hairs) in the aircraft remains centered on the display to provide lateral guidance.

Similarly, the glide slope (GS) antenna array transmits a first signal modulated at a first frequency (e.g., 90 Hz) and a second signal modulated at a second frequency (e.g., 150 Hz). The two GS signals are transmitted from co-located antennas in the GS antenna array. The center of the GS signal is arranged to define a glide path of a predetermined slope (e.g., 3°) above the ground level for the approach of the aircraft. The pilot controls the aircraft so that a guide slope indicator (e.g., cross hairs) remains centered on the display to provide vertical guidance during landing.

In aviation, the basic objective for flight inspection of the various navigation aid systems has remained much the same for the last half a century. For example, flight inspection services (FIS) are provided by an agency such as the Federal Aviation Administration (FAA), and provide airborne flight inspection of electronic signals-in-space from ground-based navigational aid equipment that support aircraft departure, en route, and arrival flight procedures. The FIS are conducted by a crew using a fleet of specially-equipped flight inspection aircraft.

Currently, for example, there are various flight maneuvers that must be performed by a flight inspection crew as part of a flight inspection of the various navigation aid systems. Each navigation aid system is inspected several times a year, and requires an aircraft fleet that is expensive to maintain, an inspection crew to fly and maintain the aircrafts, ten or more hours of flight time to accomplish, and appropriate weather to perform the flight maneuvers (e.g., not too windy and with good visibility).

Therefore, there exists an unmet need in the art for methods, apparatuses, and computer-readable media to perform the flight maneuvers required to inspect navigational aid systems using an unmanned drone that reduce the expense of maintaining a fleet of aircraft, commissioning a crew, and which allow the maneuvers to be performed under less than ideal weather conditions.

### SUMMARY

Aspects of the present invention relate to methods, systems, and computer-readable media for performing a flight check of one or more navigational aid systems. Aspects include determining, using an unmanned aircraft, an accuracy of signals transmitted by a localizer. Aspects also include determining, using the unmanned aircraft, an accuracy of signals transmitted by a glide slope station.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating one example of a system in accordance with various aspects of the present disclosure.

FIG. 2 is a flow diagram illustrating an example method for performing a flight check of one or more navigational aid systems in accordance with various aspects of the present disclosure.

FIG. 3 is a diagram illustrating example aspects of a hardware implementation for a system employing a processing system in accordance with aspects of the present disclosure.

FIG. 4 a system diagram illustrating various example hardware components and other features, for use in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a method of performing a flight check of navigational aid systems using an unmanned aircraft will now be presented with reference to various methods, apparatuses, and media. These methods, apparatuses, and media will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall implementation.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, discrete radio frequency (RF) circuits, and other suitable hardware configured to perform the various functionality described throughout this disclosure. One or more processors in the processing system may execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium or media. Computer-readable media includes computer storage media. Storage media may be any available media that is able to be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that may be used to carry or store desired program code in the form of instructions or data structures and that may be accessed by a computer. Disk and disc, as used herein, include CD, laser disc, optical disc, digital versatile disc (DVD), and floppy disk, where disks usually reproduce data magnetically, while discs reproduce data optically with lasers. Combinations of the above should also be included within the scope of computer-readable media.

Aspects of a method, apparatus, and medium presented herein may be compatible with unmanned aircraft used in performing a flight check. For example, the method, apparatus, and medium may be compatible for performing a flight check with one or more of the following: ILS, VOR, TACtical Air Navigation (TACAN), automatic dependent surveillance-broadcast (ADS-B), Marker Beacons (MB), Non-Directional Beacons (NDB), ground-based augmentation system (GBAS), Lighting Systems, and/or airport/aircraft communications, radar, and/or charts. Although the description set forth below primarily refers to a flight check procedure for an ILS, it should be understood that the methods, apparatuses, and media of the present disclosure may be used with any of the foregoing navigation aid systems listed above without departing from the scope of the present disclosure.

Currently, there are various flight maneuvers that must be performed by a flight inspection crew as part of a flight inspection of the various navigation aid systems. Each navigation aid system is inspected several times a year, and requires an aircraft fleet that is expensive to maintain, an inspection crew to fly and maintain the aircrafts, ten or more hours of flight time to accomplish, and appropriate weather to perform the flight maneuvers (e.g., not too windy and with good visibility). In order to ensure the accuracy of navigation aid systems while reducing the cost and time of performing flight checks of the various navigation aid systems, the present disclosure provides an unmanned drone that is relatively inexpensive to maintain and which is able to check the accuracy of navigation aid systems using various location information in a surveyed field. For example, the location information may be received from a global positioning system (GPS), a position monitoring station located at a surveyed point at the airport, or any other position location reporting system.

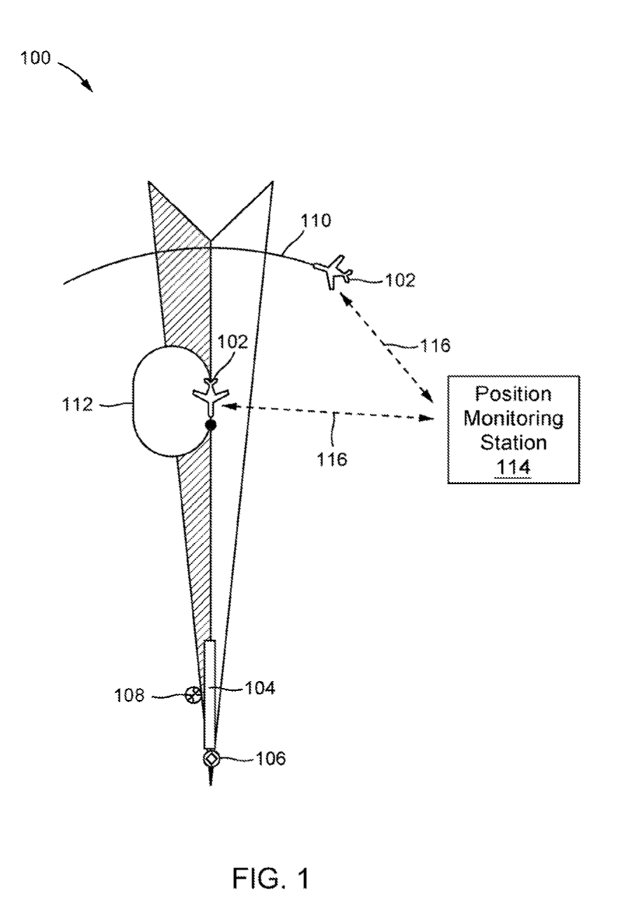

FIG. 1 illustrates an overall system diagram of an example navigation aid testing system 100 for use in accordance with aspects of the present disclosure. The example system of FIG. 1 includes, for example, an unmanned aircraft 102, a runway 104, a localizer 106, a glide slope station 108, and a position monitoring station 114. In one aspect, the unmanned aircraft 102 may be configured to learn a flight path for one or more airports depending on the navigational aid systems in use at those airports. For example, the navigational aid systems may include one or more of an ILS, VOR, DME, TACAN, ADS-B, MB, NDB, and GBAS. In another aspect, the unmanned aircraft may be a battery powered quadcopter or other drone.

In accordance with an example embodiment, the unmanned aircraft 102 may be able to test navigation aid systems (e.g., such as an ILS) by crossing 110 the ILS localizer course perpendicular to the normal direction of flight at a certain distance (e.g., 10 miles) from the airport. In an aspect, the unmanned drone 102 may be kept at a constant altitude (e.g., 2,000 ft) above the ground. During this check, the width of the transmitted localizer course (e.g., the two signals transmitted by the localizer) may be measured by the unmanned aircraft 102, and the unmanned aircraft 102 may check the accuracy of the two signals transmitted by the localizer 106. For example, the unmanned aircraft 102 may be able to determine the accuracy of the two signals transmitted by the localizer 106 based on positioning information 116 received from the a the position monitoring station 114. Alternatively, since the unmanned aircraft 102 knows a starting position of the flight check, a speed of travel, and a direction of travel, the unmanned aircraft 102 may determine the accuracy of the two signals transmitted by the localizer 106 based on location information derived by the unmanned aircraft 102. This process may ensure that a pilot will always receive correct localizer guidance during landing procedure.

In accordance with another example embodiment, the unmanned aircraft 102 may be able to test the navigation aid system (e.g., such as an ILS) by placing the unmanned aircraft 102 on a level run 112 at a constant altitude (e.g., 2,000 ft) above the ground flying along the localizer course toward the airport. This level run 112 may be made to check the glide slope station 108 of the navigational aid system and measure the actual width of the transmitted signals from the glide slope station 108, which guides the aircraft through a descent to the runway. In an aspect, the unmanned aircraft 102 may check the accuracy of the two signals transmitted by the glide slope station 108. For example, the unmanned aircraft 102 may determine the accuracy of the two signals transmitted by the glide slope station based on positioning information 116 received from the a position monitoring station 114. This process may ensure that a pilot will always receive correct glide slope guidance during a landing procedure.

In accordance with further example embodiment, the unmanned aircraft 102 may fly the complete navigational aid system approach procedure to the runway 104. This approach procedure may maneuver the unmanned aircraft 102 just above the runway so that both ends of the runway may be visually marked by sensors on the unmanned aircraft 102. The visual markings may be way-points of a GBAS at the airport that the unmanned aircraft 102 is able to develop and/or validate using the positioning information 116 received from the GPS satellite.

In this way, the unmanned aircraft 102 of the present disclosure is able to test localizer signals, glide slope signals, and VOR coverage, which would otherwise not be possible using ordinary ground check equipment and procedures. The unmanned aircraft 102 of the present disclosure is also able to develop and/or validate GBAS airport way-points with its included precision GPS capabilities. When used in conjunction with a monitor GPS, differential corrections of the localizer signals and glide slope signals using GPS positioning information ensure enhanced accuracy during the flight check procedure. As a flight check tool, the unmanned aircraft 102 is able to reduce the cost of the overall commissioning of the runway equipment, the aircraft fleet, and the flight crew. By eliminating the need for humans to man the aircraft, the unmanned aircraft of the present disclosure 102 not only greatly reduces the cost of flight checks, but allows flight checks to be performed under situations previously considered cost prohibitive.

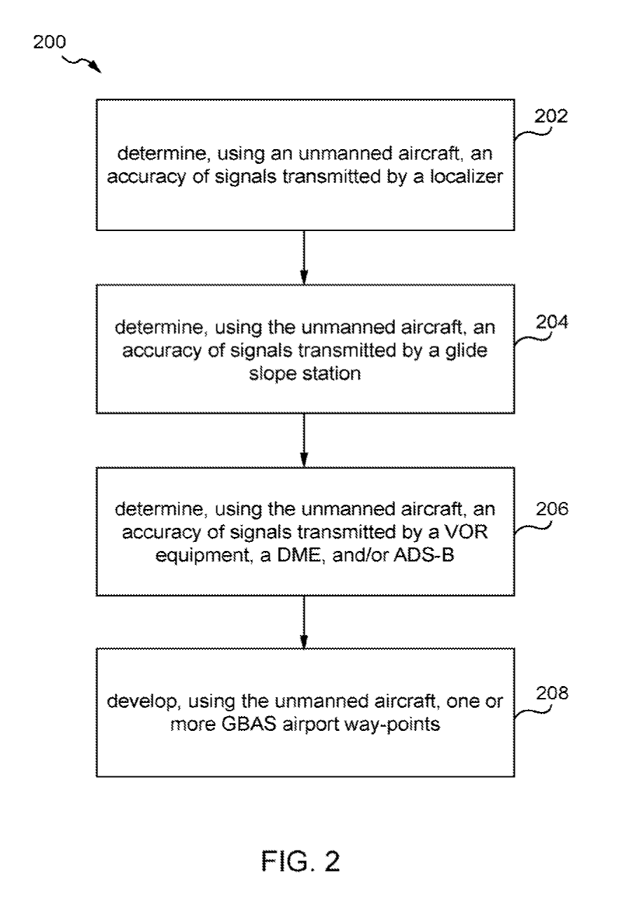

FIG. 2 is a flow diagram illustrating an example method 200 for performing a flight check of one or more navigational aid systems in accordance with various aspects of the present disclosure. The process described in this flow diagram may be implemented and/or performed by an unmanned aircraft, such as the unmanned aircraft 102 illustrated in FIG. 1. For example, the unmanned aircraft 102 may include a drone, an unmanned aerial vehicle (UAV), and/or a battery operated quadcopter. In an aspect, the unmanned aircraft 102 may be able self-flying meaning that the flight check may be performed without or with minimal human interaction. In an alternative aspect a user may remotely control the unmanned aircraft 102 for at least a portion of the flight check.

At block 202, the unmanned aircraft may determine an accuracy of signals transmitted by a localizer. For example, referring to FIG. 1, the width of the transmitted localizer course (e.g., the two signals transmitted by the localizer) may be measured by the unmanned aircraft 102, and the unmanned aircraft 102 may check the accuracy of the two signals transmitted by the localizer 106. For example, the unmanned aircraft 102 may determine the accuracy of the two signals transmitted by the localizer 106 based on positioning information 116 received from the a position monitoring station 114. Alternatively, since the unmanned aircraft 102 knows a starting position of the flight check, a speed of travel, and a direction of travel, the unmanned aircraft 102 may determine the accuracy of the two signals transmitted by the localizer 106 based on location information derived by the unmanned aircraft 102. In either example, this approach may ensure that a pilot will always receive correct localizer guidance during landing procedure, for example.

At block 204, the unmanned aircraft may determine an accuracy of signals transmitted by a glide slope station. For example, referring to FIG. 1, a level run 112 may be made by the unmanned aircraft 102 to check the glide slope station 108 of the navigational aid system by measuring the actual width of the transmitted signals from the glide slope station 108. In an aspect, the unmanned aircraft 102 may check the accuracy of the two signals transmitted by the glide slope station 108. For example, the unmanned aircraft 102 may determine the accuracy of the two signals transmitted by the glide slope station based on positioning information 116 received from the a position monitoring station 114. Alternatively, since the unmanned aircraft 102 knows a starting position of the flight check, a speed of travel, and a direction of travel, the unmanned aircraft 102 may determine the accuracy of the two signals transmitted by the localizer 106 based on location information derived by the unmanned aircraft 102. In either example, this approach may ensure that a pilot will always receive correct localizer guidance during landing procedure, for example.

At block 206, the unmanned aircraft may determine the accuracy of signals transmitted by VOR equipment, a DME, and/or ADS-B. For example, referring to FIG. 1, the unmanned aircraft 102 may be configured to learn a flight path for one or more airports, depending on the navigational aid systems in use at those airports. For example, the navigational aid systems may include one or more of an ILS, VOR, DME, TACAN, ADS-B, MB, NDB, and GBAS.

At block 208, the unmanned aircraft may develop one or more GBAS airport way-points. For example, referring to FIG. 1, the unmanned aircraft 102 may fly the complete navigational aid system (e.g., ILS) approach procedure to runway 104. This approach procedure may maneuver the unmanned aircraft 102 just above the runway so that both ends of the runway may be visually marked by sensors on the unmanned aircraft 102. The visual markings may be way-points of a GBAS at the airport that the unmanned aircraft 102 is able to develop and/or recognize using positioning information 116 received from the GPS satellite.

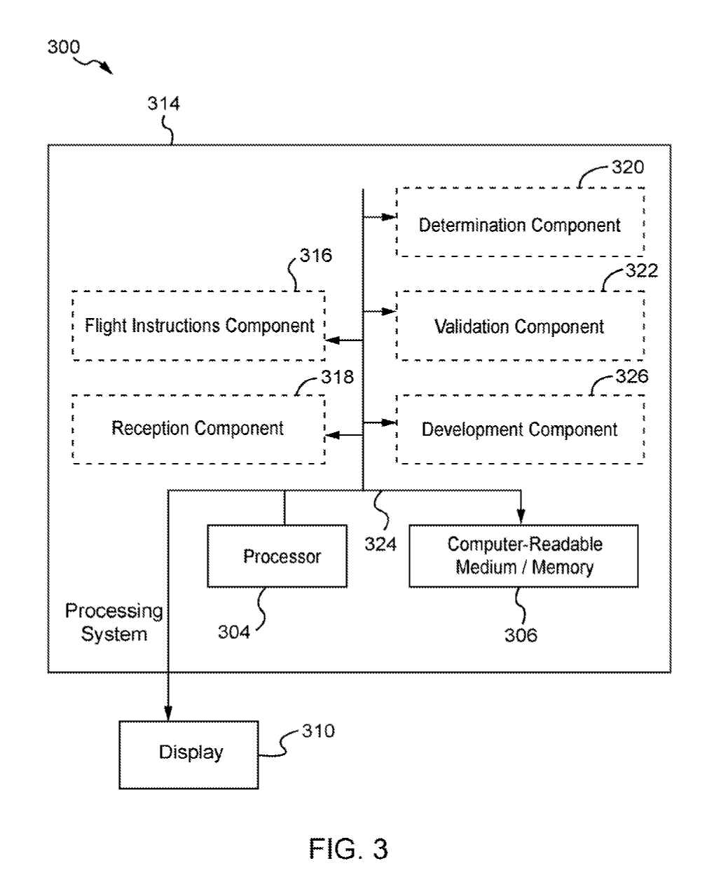

FIG. 3 is a representative diagram illustrating an example hardware implementation for a system 300 employing a processing system 314. The processing system 314 may be implemented with an architecture that links together various circuits, including, for example, one or more processors and/or components, represented by the processor 304, the components 316, 318, 320, 322, 326 and the computer-readable medium/memory 306.

The processing system 314 may be coupled to or connected with an unmanned aircraft.

The processing system 314 may include a processor 304 coupled to a computer-readable medium/memory 306 via bus 324. The processor 304 may be responsible for general processing, including the execution of software stored on the computer-readable medium/memory 306. The software, when executed by the processor 304, may cause the processing system 314 to perform various functions described supra for any particular apparatus and/or system. The computer-readable medium/memory 306 may also be used for storing data that is manipulated by the processor 404 when executing software. The processing system may further include at least one of the components 316, 318, 320, 322, 326. The components may comprise software components running in the processor 304, resident/stored in the computer readable medium/memory 406, one or more hardware components coupled to the processor 304, or some combination thereof. The processing system 314 may comprise a component navigational aid system 100, as illustrated in FIG. 1.

The system 300 may further include features for determining, using an unmanned aircraft, an accuracy of signals transmitted by a localizer, features for determining, using the unmanned aircraft, an accuracy of signals transmitted by a glide slope station, features for determining, using the unmanned aircraft, an accuracy of signals transmitted by a VOR equipment, a DME, and/or ADS-B and features for developing, using the unmanned aircraft, one or more GBAS airport way-points.

The aforementioned features may be carried out via one or more of the aforementioned components of the system 300 and/or the processing system 314 of the system 300 configured to perform the functions recited by the aforementioned features.

Thus, aspects may include a system for performing a flight check of one or more navigational aid systems, e.g., in connection with FIG. 2.

The system may include additional components that perform each of the functions of the method of the aforementioned flowchart of FIG. 2, or other algorithm. As such, each block in the aforementioned flowchart of FIG. 2 may be performed by a component, and the system may include one or more of those components. The components may include one or more hardware components specifically configured to carry out the stated processes/algorithm, implemented by a processor configured to perform the stated processes/algorithm, stored within a computer-readable medium for implementation by a processor, or some combination thereof.

Thus, aspects may include a non-transitory computer-readable medium for performing a flight check of one or more navigational aid systems, the non-transitory computer-readable medium having control logic stored therein for causing a computer to perform the aspects described in connection with, e.g., FIG. 2.

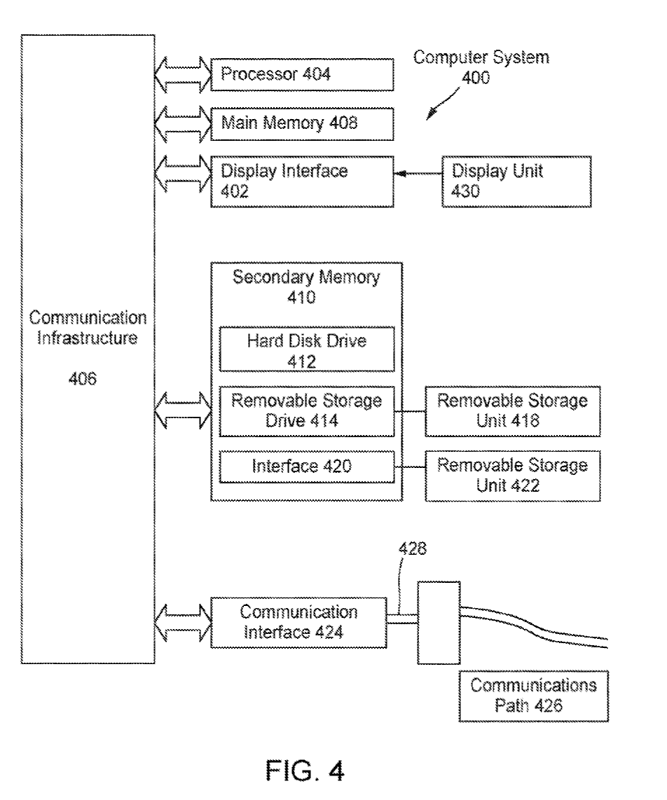

FIG. 4 is an example system diagram of various hardware components and other features, for use in accordance with aspects presented herein. The aspects may be implemented using hardware, software, or a combination thereof and may be implemented in one or more computer systems or other processing systems. In one example, the aspects may include one or more computer systems capable of carrying out the functionality described herein, e.g., in connection with FIG. 2. An example of such a computer system 300 is shown in FIG. 3.

In FIG. 4, computer system 400 includes one or more processors, such as processor 404. For example, the processor 404 may be configured for signal processing at an unmanned aircraft. The processor 404 is connected to a communication infrastructure 406 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 400 can include a display interface 402 that forwards graphics, text, and other data from the communication infrastructure 406 (or from a frame buffer not shown) for display on a display unit 430. In an aspect, the display unit 430 may be included in an unmanned aircraft. In another aspect, the display unit 430 may be located remote from the unmanned aircraft and configured to display data and/or measurements obtained using the unmanned aircraft. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, wireless communications link, a radio frequency (RF) link and/or other communications channels. In this document, the terms “computer program medium” and “computer usable medium” are used to refer generally to media such as a removable storage drive 480, a hard disk installed in hard disk drive 412, and signals 428. These computer program products provide software to the computer system 400. Aspects presented herein may include such computer program products.

Computer programs (also referred to as computer control logic) are stored in main memory 408 and/or secondary memory 410. Computer programs may also be received via communications interface 424. Such computer programs, when executed, enable the computer system 400 to perform the features presented herein, as discussed herein. In particular, the computer programs, when executed, enable the processor 410 to perform the features presented herein. Accordingly, such computer programs represent controllers of the computer system 400.

In aspects implemented using software, the software may be stored in a computer program product and loaded into computer system 400 using removable storage drive 414, hard drive 412, or communications interface 420. The control logic (software), when executed by the processor 404, causes the processor 404 to perform the functions as described herein. In another example, aspects may be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A method for performing a flight check of one or more navigational aid systems, comprising:
receiving, from an unmanned aircraft, a data packet that includes one or more of information associated with signals transmitted by a localizer, information associated with signals transmitted by a glide slope station, information associated with signals transmitted by very high frequency (VHF) omnidirectional range (VOR) equipment, or location information associated with a position of the unmanned aircraft;
determining, using an unmanned aircraft, an accuracy of signals transmitted by a localizer; and
determining, using the unmanned aircraft, an accuracy of signals transmitted by a glide slope station.

2. The method of claim 1, wherein the data packet is received via one of a wired or a wireless connection.

3. The method of claim 1, wherein:
the accuracy of the signals transmitted by the localizer and the accuracy of the signals transmitted by the glide slope station are both determined based on location information received by the unmanned aircraft.

4. The method of claim 1, further comprising:
determining, using an unmanned aircraft, an accuracy of signals transmitted by VOR equipment.

5. The method of claim 4, wherein the accuracy of the signals transmitted by the VOR system is determined based on location information received by the unmanned aircraft.

6. The method of claim 4, wherein the localizer, the glide slope station, and the VOR equipment are all part of an instrument landing system (ILS) used when landing an aircraft on a runway.

7. The method of claim 1, further comprising:
developing one or more ground-based augmentation system (GBAS) airport way-points using integrated global positioning system (GPS) associated with the unmanned aircraft.

8. The method of claim 1, further comprising:
validating existing ground-based augmentation system (GBAS) airport way-points using an integrated global positioning system (GPS) associated with the unmanned aircraft.

9. The method of claim 1, further comprising:
configuring the unmanned aircraft for learning mode in order to capture a flight plan.

10. The method of claim 1, wherein the unmanned aircraft is configured to fly a prerecorded course collecting data associated with the flight checks of the ILS and VOR equipment, wherein the collected data is stored in the internal memory of the unmanned aircraft.

11. The method of claim 1, further comprising:
testing, using the unmanned aircraft, at least one of a distance measuring equipment (DME) or automatic dependent surveillance-broadcast (ADS-B) equipment.

12. The method of claim 1, wherein the unmanned aircraft includes one of a drone, an unmanned aerial vehicle (UAV), and/or a battery operated quadcopter.

13. An apparatus for performing a flight check of one or more navigational aid systems, comprising:
a memory; and
one or more processors coupled to the memory and configured to:
receive, from an unmanned aircraft, a data packet that includes one or more of information associated with signals transmitted by a localizer, information associated with signals transmitted by a glide slope station, information associated with signals transmitted by very high frequency (VHF) omnidirectional range (VOR) equipment, or location information associated with a position of the unmanned aircraft;
determine, using an unmanned aircraft, an accuracy of signals transmitted by a localizer; and
determine, using the unmanned aircraft, an accuracy of signals transmitted by a glide slope station.

14. The apparatus of claim 13, wherein the data packet is received via one of a wired or a wireless connection.

15. The apparatus of claim 13, wherein:
the accuracy of the signals transmitted by the localizer and the accuracy of the signals transmitted by the glide slope station are both determined by the one or more processors based on location information received by the unmanned aircraft.

16. The apparatus of claim 13, wherein the one or more processors are further configured to:
determine, using an unmanned aircraft, an accuracy of signals transmitted by VOR equipment.

17. The apparatus of claim 16, wherein the accuracy of the signals transmitted by the VOR system is determined by the one or more processors based on location information received by the unmanned aircraft.

18. The apparatus of claim 16, wherein the localizer, the glide slope station, and the VOR equipment are all part of an instrument landing system (ILS) used when landing an aircraft on a runway.

19. The apparatus of claim 13, wherein the one or more processor are further configured to:
develop one or more ground-based augmentation system (GBAS) airport way-points using integrated global positioning system (GPS) associated with the unmanned aircraft.

20. The apparatus of claim 13, wherein the one or more processor are further configured to:
validate existing ground-based augmentation system (GBAS) airport way-points using an integrated global positioning system (GPS) associated with the unmanned aircraft.

21. The apparatus of claim 13, wherein the one or more processor are further configured to:
configure the unmanned aircraft for learning mode in order to capture a flight plan.

22. The apparatus of claim 13, wherein the unmanned aircraft is configured to fly a preredorded course collecting data associated with the flight checks of the ILS and VOR equipment, wherein the collected data is stored in the internal memory of the unmanned aircraft.

23. The apparatus of claim 13, wherein the one or more processor are further configured to:
test, using the unmanned aircraft, at least one of a distance measuring equipment (DME) or automatic dependent surveillance-broadcast (ADS-B) equipment.

24. The apparatus of claim 13, wherein the unmanned aircraft is a drone, an unmanned aerial vehicle (UAV), and/or a battery operated quadcopter.

25. A computer-readable medium storing computer executable code for performing a flight check of one or more navigational aid systems, comprising code for:
receiving, from an unmanned aircraft, a data packet that includes one or more of information associated with signals transmitted by a localizer, information associated with signals transmitted by a glide slope station, information associated with signals transmitted by very high frequency (VHF) omnidirectional range (VOR) equipment, or location information associated with a position of the unmanned aircraft;
determining, using an unmanned aircraft, an accuracy of signals transmitted by a localizer; and
determining, using the unmanned aircraft, an accuracy of signals transmitted by a glide slope station.
